(19) United States
(12) Patent Application Publication
(10) Pub. No.: US 2014/0335425 A1
(43) Pub. Date: Nov. 13, 2014

(54) PROTON/CATION TRANSFER POLYMER

(71) Applicants: Nathan Lawrence, Cambridgeshire (GB); Steven Antony Gahlings, Cambridgeshire (GB)

(72) Inventors: Nathan Lawrence, Cambridgeshire (GB); Steven Antony Gahlings, Cambridgeshire (GB)

(21) Appl. No.: 14/274,543

(22) Filed: May 9, 2014

Related U.S. Application Data
(60) Provisional application No. 61/821,374, filed on May 9, 2013.

(51) Int. Cl. C08G 8/04; H01M 10/0565; H01M 10/052; G01N 27/333

(52) U.S. Cl. CPC C08G 8/04; G01N 27/3335; H01M 10/0565; H01M 10/052; H01M 2300/0082
USPC 429/306; 204/421; 205/171; 205/792.5; 521/39

(57) ABSTRACT

A polymer that provides for effective proton/cation transfer within, through, across the polymer. The polymer may be used in an electrochemical sensor and may include a redox active species and a facilitator of proton transfer that may provide for the “shuttling”/transfer of a proton through the polymer. As such, the polymer may provide for protons to be transferred through the polymer from or to a conducting substrate. The polymer may also provide for separation of components, fluids, materials in an electrochemical system while still allowing for a transfer, shuttling of protons or cations between the components, fluids or material. The proton, cation transfer polymer may be used in a battery, an electrochemical sensor or a fuel cell.

### CROSS-REFERENCE TO RELATED APPLICATIONS

This application is a non-provisional of U.S. provisional application No. 61/821,374, filed May 9, 2013, entitled “ELECTROCHEMICAL SENSING USING A PROTON TRANSFER POLYMER,” which is incorporated by reference in its entirety for any and all purposes.

### BACKGROUND

Electrochemistry is important in many different fields. For example, electrochemistry is important in batteries, electrochemical sensors and fuel cells. In many electrochemical technologies it may be desirable to be able to separate, protect and/or isolate components of a system, which may comprise electrodes, fluids and/or the like, using a material through which charged particles/ions can pass/shuttle.

In the sensor field, there are numerous circumstances in which it is desirable to detect, measure or monitor a constituent of a fluid. One of the commonest requirements is to determine hydrogen ion concentration (generally expressed on the logarithmic pH scale) in aqueous fluids. pH, or potential of hydrogen, is a measure of the acidity or alkalinity of a solution. The pH of a solution is determined by the concentration, or more correctly, the activity of hydrogen ions (H.sup.+), also referred to as protons, within the solution. As concentration of protons increases, the solution becomes more acidic, and the solution becomes more basic as the concentration of protons within the solution decreases. The determination of the pH of a solution is one of the most common analytical measurements and can be regarded as one of the most critical parameters in chemistry. Merely by way of example, pH measurement is important in the pharmaceutical industry, the food and beverage industry, the treatment and management of water and waste, chemical and biological research, analytical chemistry, chemical process control, reaction monitoring, laboratory chemistry and/or the like.

Previously, pH has been measured using a glass electrode probe connected to an electronic meter that displays the pH reading. A traditional pH probe or glass electrode is a type of ion-selective electrode made of a fragile, doped glass membrane that is sensitive to protons. This pH-responsive glass membrane is the primary sensing element in this type of probe. Protons within the sample solution bind to the outside of the glass membrane thereby causing a change in potential on the interior surface of the membrane. This change in potential is measured against the constant potential of a reference electrode such as the silver/silver chloride reference electrode. The difference in potential is then correlated to a pH value by plotting the difference on a calibration curve. The calibration curve is created through a tedious, multistep process whereby the user plots changes in potential for various known buffer standards. Most traditional pH sensors are based on variations of this principle.

The accuracy and reliability of traditional pH glass electrodes are unstable and therefore require careful, regular calibration and care involving tedious, time-consuming processes requiring multiple reagents and a well-trained technician. The special properties and construction of the glass electrodes further require that the glass membrane be kept wet at all times. Thus, routine care of the glass probe requires regular performance of cumbersome and costly storage, rinsing, cleaning and calibration protocols by a well-trained technician to ensure proper maintenance and working condition of the probe.

In addition to tedious maintenance, traditional glass electrodes are fragile thereby limiting field applicability of the glass electrode. In particular, the fragile nature of the glass electrode is unsuitable for use in food and beverage applications, as well as use in unattended, harsh or hazardous environments. Accordingly, there is a need in the art for a pH probe that addresses and overcomes the limitations of the traditional pH glass electrode. Such a pH probe device is disclosed herein.

The need for constant recalibration to provide an accurate pH output significantly impedes industrial applications especially where constant in-line pH measurements are required. Recalibration is particularly cumbersome in a biotech environment where pH measurement is conducted in medium containing biological materials. Another significant drawback of conventional pH sensors is that the glass electrodes have internal solutions, which in some cases can leak out into the solution being measured. The glass electrodes can also become fouled by species in the measuring solution, e.g., proteins, causing the glass electrode to foul.

As well as pH, there are many other analytes for which a reliable, easy to use sensor is desirable. In fact the analytes are too numerous to list. Merely by way of example, sensors for detecting measuring biological constituents, nitrates, sulphites, calcium, borates, magnesium, carbon dioxide, oxygen and/or the like are desirable. Previously, various forms of electrochemical sensors have been proposed for measuring many different analytes, including pH. These electrochemical sensors are based upon measuring potentiometric effects or voltammetric effects produced by the analyte to be measured/detected interacting with a redox species that is sensitive to the presence of the analyte. For example, a reduction/oxyidation current resulting from the reduction/oxidation of the sensitive redox species may be increased in the presence of the analyte. Similarly, a reduction/oxidation potential of the sensitive redox species may be increased/shifted by the presence of the analyte. By measuring/detecting the changes in the reduction/oxidation current/potential of the sensitive redox species the analyte may be detected/measured.

In a common electrochemical arrangement an anthraquinone is used as a redox sensitive species. Changes in the reduction/oxidation current/potential of the anathraquinone are used to measure/detect the analyte. In an electrochemical sensor a reference electrode is used. This reference electrode may comprise a silver chloride electrode, an ionic liquid and/or the like. In some electrochemical sensors, a non-sensitive redox species, i.e. a species that is not affected by the presence of the analyte to be measured is used as a reference. A common non-sensitive redox species is ferrocene or a derivative thereof. An advantage of using a non-sensitive redox species in the electrochemical sensor is that the behavior of the insensitive redox accounts for drift in the response of the sensitive redox species.

In an electrochemical sensor, the sensor can be tuned to detect/measure different analytes by selection of an appropriate redox species. For example, a redox species may be sensitive to one analyte, the presence of the analyte affecting the reduction/oxidation current/potential of the redox species, but may be insensitive to the presence of other analytes. Furthermore, the same redox species may be sensitive to a number of different analytes. This may be advantageous as changes in the reduction/oxidation current/potential of the redox species may occur at different potentials for different analytes so the detection/measurement of multiple analytes may be possible with a single redox species.

Because of the properties of electrochemical sensors—such as, among other things, their simplicity, accuracy, lack of calibration requirements, ability to be tuned to analytes, solid state nature and/or the like—electrochemical sensors have been developed and commercialized for the detection/measurement of a range of different analytes. However, previous electrochemical sensors have had several issues that have prevented/attenuated their full utilization.

A problem with electrochemical sensors using sensitive redox species is interference. Interference occurs when an analyte in the solution being analyzed that is not of interest affects the current/potential measured by the electrochemical sensor. This may occur when an analyte has an electrical interaction—proton/electron exchange—with the electrode/substrate with which the sensitive redox species is in electrical communication. Interferences can prevent the reduction/oxidation current/potential of the sensitive redox species being accurately determined. Moreover, interferences are particularly detrimental to use of electrochemical sensors for multi-analyte detection/measurement as such detection/measurement requires detection/determination of multiple reduction/oxidation currents/potentials, which may not be possible against an uncertain electrical background. Interference may also be disadvantageous when the electrochemical sensor is being used in adverse conditions such as when the analyte/fluid the analyte is present within has a low ionic concentration, thereby reducing detectable reduction/oxidation current/potential. Moreover, interferences may be especially disadvantageous in biological, process control, food & beverage industries where the presence of interferences and active/reactive interferences may occur alongside the analyte to be detected. Interferences may be produced for example by peroxides, ascorbic acid and/or the like. Furthermore, interference effects have often prevented operation of electrochemical sensors by preventing effective use of chemistries for adjusting the pH in front of the sensing electrode, providing techniques addressing lack of ionic concentration in the fluid to be analyzed, for tuning of a detection system to the expected reduction/oxidation potential and/or the like.

Because of the detrimental effect of interference on electrochemical sensor operation, previously several approaches have been suggested to mitigate/remove the interference effect. One such method involves using a blank electrode, i.e., one with no redox species attached, to determine an interference profile and using this profile to process/interpret the reduction/oxidation current/potential produced by the sensitive redox species.

Another issue with electrochemical sensors is solubility of the redox species that is used. This is particularly important with respect to biological/in vivo uses of electrochemical sensors and/or monitoring in the health and food industries. The sensitive redox species may comprise chemistries that are not desirable/toxic and as such loss of the sensitive redox species during testing may not be allowed, even at low levels. A further issue, is response time, to use electrochemical sensors for process control, analytical purposes it may be desirable to have fast/instantaneous measurement/detection of an analyte.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth.

In one embodiment, a polymer is described that provides for effective proton transfer within/through the polymer. In such an embodiment, the polymer comprises a redox active species/center/moiety polymer and/or a facilitator of proton transfer that provides for “shuttling”/transfer of a proton through the polymer. As such, the polymer may provide for protons to be transferred through the polymer from/to a conducting substrate. Then polymer may provide for separation of components/fluids/materials in an electrochemical system while still allowing for a transfer of protons between the components, fluids, materials and/or the like. In some embodiments, the proton transfer polymer may be sued in a battery, an electrochemical sensors, a fuel cell and/or the like.

In some embodiments of the present invention, an electrode for an electrochemical sensor comprises a polymer that comprises a redox active species/center/moiety, wherein the polymer comprises a facilitator of proton transfer that provides for “shuttling” of a proton from a solution being analyzed through the polymer to a conducting substrate coupled with the polymer. The term redox active center is used to describe a chemistry/redox active species/moiety that is sensitive to an analyte to be detected/measured and that is attached to/integrated into the polymer. Because the polymer is configured to effectuate/support proton transfer through the polymer, in use the polymer provides for proton transfer from the solution in which the electrode is in contact to the redox active centers and/or the substrate on which the polymer is disposed. For purposes of this disclosure, the polymer, in accordance with embodiments of the present invention, may be referred to as a proton transfer polymer or “PTP”.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 illustrates the effect of interferences contacting an electrode in an electrochemical sensor system.

FIG. 2 illustrates an example of a proton transfer polymer comprising a redox sensitive species, in accordance with one embodiment of the present invention.

FIG. 3A shows square wave voltammetric response of an electrode comprising a proton transfer molecule in accordance with an embodiment of the present invention.

FIG. 3B illustrates square wave voltammetric response of an electrode comprising a proton transfer molecule, in accordance with an embodiment of the present invention, disposed in a pH 2 buffer solution.

FIG. 4A illustrates square wave voltammetric response of an electrode comprising a proton transfer molecule, in accordance with an embodiment of the present invention, disposed in a solution as the pH of the solution is increased.

FIG. 4B illustrates a plot of oxidative peak potential as a function of pH for an electrode comprising a proton transfer molecule, in accordance with an embodiment of the present invention.

FIG. 5 illustrates an oxidation polymerisation mechanism for salicyaldehyde, a proton transfer polymer in accordance with one embodiment of the present invention.

FIG. 6 illustrates a voltammetric response of a layer of a proton/cation transfer polymer, in accordance with an embodiment of the present invention, when placed in pH 4, 7 and 9 buffered solutions and when placed in mineral water solution (solid line).

FIG. 7 illustrates a response of a newly formed layer of a proton/cation transfer polymer, in accordance with an embodiment of the present invention, to additions of ascorbic acid when layer is disposed in a pH 7 solution.

FIG. 8 details the square wave voltammetric response of a thick polymer film (greater than 1 mono later of coverage) to increasing additions of ascorbic acid

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In one embodiment, a polymer is described that provides for effective proton/cation transfer within/through/across the polymer. In some embodiments, the polymer may comprise a redox active species/center/moiety and/or a facilitator of proton/cation transfer that provides for “shuttling”/transfer of a proton through the polymer. As such, the polymer may provide for protons/cations to be transferred through the polymer from/to a conducting substrate. The polymer may provide for separation of components/fluids/materials in an electrochemical system while still allowing for a transfer of protons/cations between the components, fluids, materials and/or the like. In some embodiments, the proton transfer polymer may be used in a battery, an electrochemical sensors, a fuel cell and/or the like.

In some embodiments of the present invention, an electrode for an electrochemical sensor comprises a polymer that comprises a redox active species/center/moiety, wherein the polymer comprises a facilitator of proton transfer that provides for “shuttling” of a proton from a solution being analyzed through the polymer to a conducting substrate coupled with the polymer. The term redox active center is used to describe a chemistry/redox active species/moiety that is sensitive to an analyte to be detected/measured and that is attached to/integrated into the polymer. Because the polymer is configured to effectuate/support proton transfer through the polymer, in use the polymer provides for proton transfer from the solution in which the electrode is in contact to the redox active centers and/or the substrate on which the polymer is disposed.

In embodiments of the present invention, the PTP comprises a polymer chemistry that provides for effective proton transfer through the polymer. At the same time, in embodiments of the present invention, the PTP comprises redox sensitive centers that are sensitive to the presence of an analyte to be detected/measured. In some embodiments, the polymers is configured such that a proton transfer moiety is attached to the polymer structure so that it is proximal to the redox sensitive species/center/moiety that is also attached to the polymer structure.

In some embodiments of the present invention, passivation comprises prevention of direct electron transfer between an interferent in the solution being analyzed and the electrode/substrate. Passivation is provided by using dimensions (thickness) of the PTP that are sufficient to prevent electron transfer occurring between the fluid being tested and/or any of its constituents and the electrode/substrate on which the PTP is disposed. In embodiments of the present invention, by coupling a sensitive redox species with/integrating a sensitive redox species in a polymer that is configured to transfer protons and by using a thickness of the polymer to prevent electron transfer to the electrode/substrate with which the sensitive redox is coupled, an electrochemical sensor is provided that can measure/detect one or more specific anlaytes without interference from other analytes.

Proton transfer polymers comprise polymers that include a moiety that is a facilitator of proton transfer through the polymer and the redox sensitive species comprises a coordinating group with respect to the ion of interest in the solution being analyzed. In embodiments, at least one of the proton facilitator and the coordinating group may be coupled to the backbone of the polymer or coupled by a branch structure to the polymer. In some embodiments, the polymer may be formed from a copolymer that includes the proton transfer facilitator and a copolymer that does not include the proton transfer facilitator. In such embodiments, the proton transfer properties of the polymer and passivation properties of the polymer may be tuned, i.e. the polymer may be “tightened” to prevent diffusion of moieties that produce interference through the polymer.

In embodiments of the present invention, the sensitive redox species, active redox center and/or sensitive redox moiety may be disposed in, coupled with, chemically integrated with the polymer. Merely by way of example, the redox species may be chemically integrated with the polymer. Such integration may comprise simply reacting copolymers and the sensitive redox species to produce a PTP that incorporates the sensitive redox species. However, applicants have in some embodiments attached sensitive redox species to the backbone of the PTP. In such embodiments, the sensitive redox species may be evenly distributed through the PTP. In yet other embodiments, the PTP may be disposed on the electrode/substrate and the sensitive redox species attached to an active surface of the PTP.

For purposes of this disclosure, an electrode for an electrochemical sensor may comprise the PTP, which itself comprises a redox active and/or pH active moiety, in a film/layer disposed upon the sensing electrode surface. As such, the PTP is itself redox active. In embodiments of the present invention, the film/layer allows rapid proton transport from the analyte solution to the redox active center/electrode substrate, however, the film layer is thick enough to inhibit direct electron transfer between an interferent and the electrode substrate.

The PTP may be coupled with the electrode/substrate in many different ways. For example, the passivation polymer/PTP may simply be disposed upon the electrode/substrate, it may be chemically bound to the electrode/substrate, it may be screen-printed onto the electrode/substrate, it may be solvent cast onto the electrode/substrate, it may be applied to the electrode using semiconductor fabrication processes and/or the like. In embodiments of the present invention, the electrode/substrate may comprise a conducting material and may comprise metal, carbon, silicon, conducting diamond and/or the like. Applicants have found that unlike many previous sensitive redox species, proton transport polymers with integrated sensitive redox species may be effectively coupled with the electrode/substrate using many different processes. In embodiments of the present invention, the PTP may be electrochemically oxidized in a one electron one proton oxidation so as to form a polymeric, water-insoluble, redox-active deposit on the conductive surface. In embodiments of the present invention, this electrochemically oxidation of the PTP is performed a plurality of times to provide that multiple layers of the PTP are formed on the electrode. In aspects of the present invention the PTP is electrochemically cycled onto the electrode.

As discussed above, an issue with respect to electrochemical sensors are redox active interferences. The presence of such species may produce voltammetric waves, and may cause erroneous results.

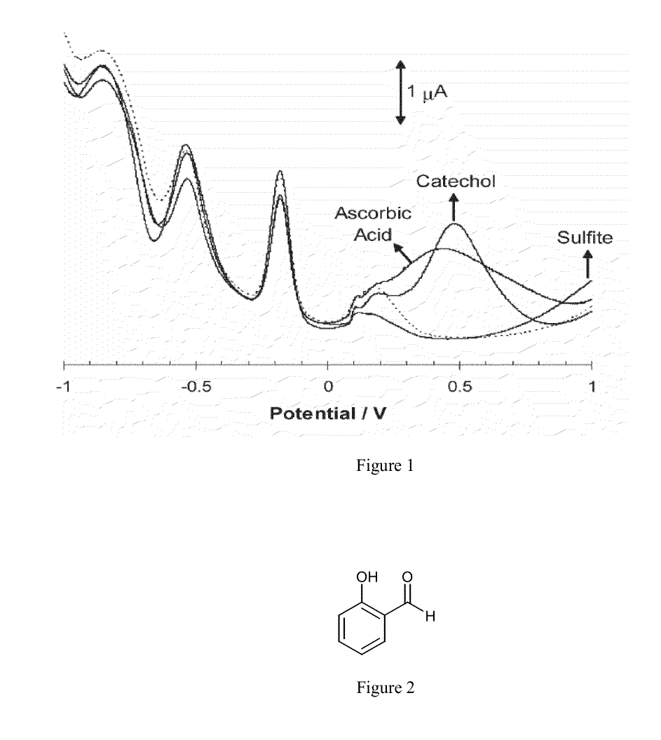

In FIG. 1, square wave voltammetric responses from an electrochemical sensor are illustrated in the absence (dashed line) and presence (solid line) of interferences, 0.5 mM ascorbic acid, catechol and sulfite (measured at pH 7, using a phosphate buffer). In the presence of the interferences, new oxidation waves are observed in the voltammetric responses at +0.45 volts (“V”) and +0.50 V for ascorbic acid and catechol, with a slight increase in the oxidative current recorded at 0.90 V in the case of sulfite.

In FIG. 1, it can be seen that the presence of the interferences has no effect on the voltammetric signal of the pH active waves (anthraquinone and ahenanthraquinone), with well-defined waves observed. In the case of ferrocene, as noted above ferrocene is often used in electrochemical sensors as a non-sensitive redox species, both catechol and ascorbic acid oxidize at potentials close to ferrocene and this oxidation can mask the ferrocene wave. In addition to masking the redox waves of ferrocene, redox sensitive species that produce voltammetric waves in the presence of an analyte to be detected where the waves are at higher potentials will be masked. This is especially important since such high potential redox sensitive species may be used in electrochemical sensors that can operate in low ionic strength fluids.

Methods have been proposed previously for overcoming the interferences, such as the use of a second uncoated electrode in the electrochemical sensor, which can be used as a control and the signal from this subtracted from the modified electrodes. Films and polymer coatings, which inhibit diffusion of the interference species to the electrode, that are disposed over the redox sensitive species and the surface of the electrode/substrate have also been proposed. However, such films and coatings may reduce the response time of the sensor, interfere with the redox sensitive species/analyte interaction and/or the like. Finally, use of alternative redox sensitive species, which have different redox potentials to that of the interfering species, has also been proposed. This solution limits the capabilities of the electrochemical sensor and is not effective if the presence of the interfering species is unknown or not predicted.

Although each of these ideas will overcome the issue discussed they do have some drawbacks, in the case of using an additional blank electrode, the redox signal of the interfering species has to be the same for both the modified and unmodified electrode. For the polymer layer the response of the sensor is delayed as the polymer layer has to hydrate before it can reproducibly respond to the pH of the solution.

Embodiments of the present invention provide means of overcoming the presence of redox activities using the electrochemical oxidation of a proton transfer polymer comprising a redox sensitive species. Proton transfer polymers comprise a proton transfer facilitator that provides that protons are transferred effectively through the polymer. The redox sensitive species may comprise a moiety that is sensitive to a presence of an analyte and is chemically attached to the polymer. Merely by way of example a redox sensitive species may be attached to the backbone of the polymer. Attachment to the backbone may provide for disbursement/even distribution of the redox sensitive species/moiety and/or the proton facilitating moiety throughout the polymer. In the proton transfer polymer, a proton donation interaction from an analyte to the redox sensitive species in an oxidation interaction causes a proton to be transferred through the proton transfer polymer to the electrode on which it is disposed. This electron transfer is visible in a voltammetric response of the electrochemical sensor and provides for detection/measurement of the analyte.

FIG. 2, illustrates an example of a proton transfer polymer comprising a redox sensitive species, in accordance with one embodiment of the present invention. In accordance with the depicted embodiment, the proton transfer polymer comprises a phenol derivative. In the illustrated phenol derivatives, the carbonyl group is three carbons from the alcohol moiety to be oxidised.

In an embodiment of the present invention, electrochemical interrogation was sought using an active electrode produced by immobilising the molecules of FIG. 2 on the surface of the electrode by solvent evaporation. The molecules were first dispersed (A) or dissolved (B) in dichloromethane (DCM (1 mg/mL)) from which an aliquot was dispersed onto a glassy carbon electrode. The electrode was then placed into pH 4 buffer and square wave voltammetry was used to assess the electrochemical response.

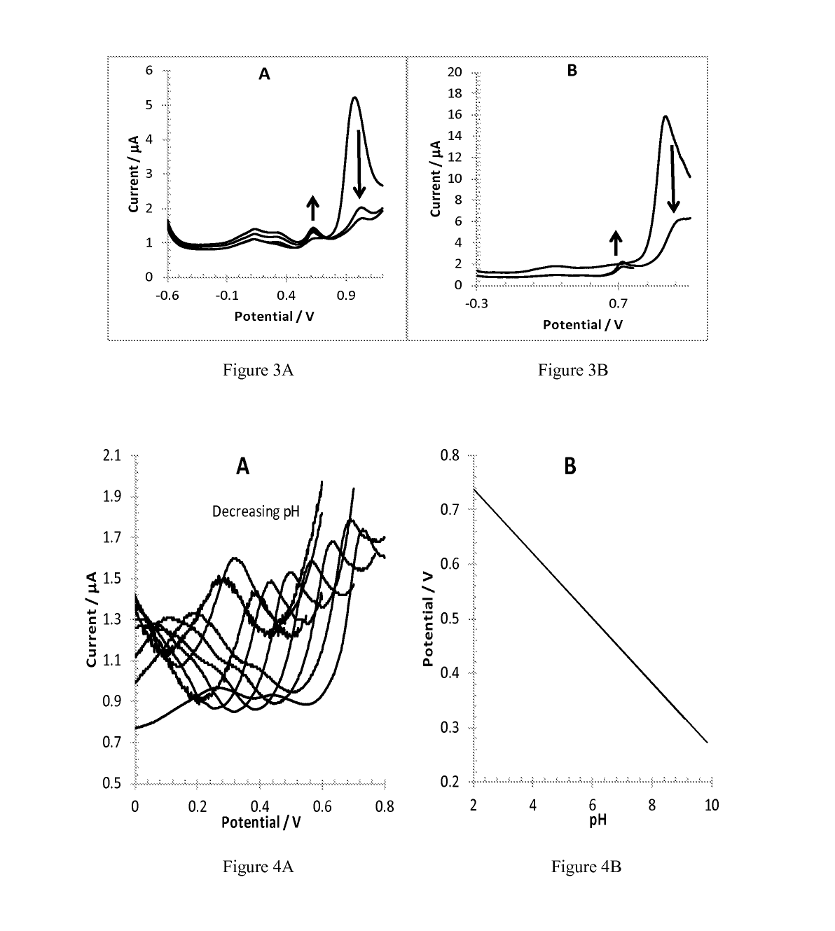

FIG. 3A details the repetitive square wave voltammetric (Frequency=25 Hz, Step Potential=2 mV, Amplitude=0.02V) response of the electrode comprising a proton transfer molecule in accordance with an embodiment of the present invention. It can be seen from the figure that the initial scan shows a large oxidative wave at +0.95V. The second and subsequent scans show a large decrease in this oxidative peak current and the emergence of a new redox wave at +0.59V, which continues to grow.

FIG. 3B shows the response when a freshly prepared electrode was placed in pH 2 Britton-Robinson buffer solution and the analogous experiment undertaken. As with the pH 4 response shown above, the initial scan shows a large oxidative wave at +1.01V, with a new wave emerging at +0.71V upon repetitive scanning.

To understand the properties of the new electroactive wave further the influence of pH on the signal was assessed. FIG. 4A details the SWV response when the newly formed electroactive species, after the oxidation of salicyaldehyde, was placed in Britton-Robinson buffer (pH 2.0) and the pH of the solution increased by additions of concentrated NaOH. As expected as the pH of the solution is increased from 2 to 10, the oxidative peak shifts to lower potentials. The corresponding plot of oxidative peak potential as a function of pH is shown in FIG. 4B (squares) this was found to be linear over the entire pH range studied with a slope of 60.4 mV/pH unit, consistent with an n electron, n proton redox process.

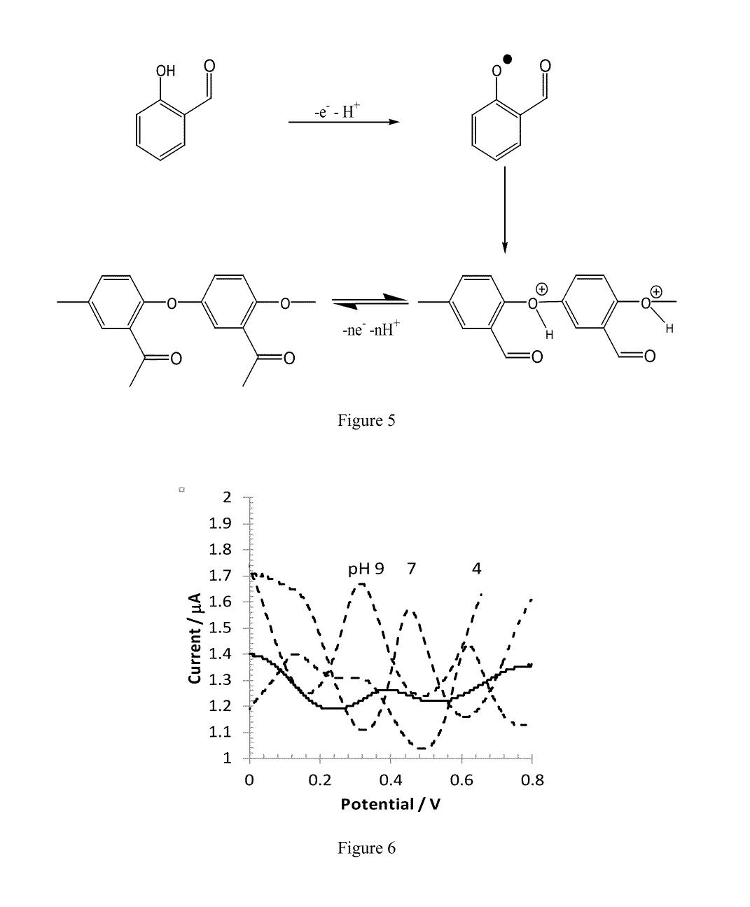

FIG. 5 details one oxidation polymerisation mechanism for salicyaldehyde, a proton transfer polymer, in accordance with an embodiment of the present invention. The oxidation of phenols typically result in the formation polymeric species, as the newly formed radical cation attacks a parent phenol species para to the hydroxyl moiety.

It has been shown that this newly formed redox active polymeric layer can be used for determining the pH of an unbuffered media, this is highlighted in FIG. 6, which details the voltammetric response of the layer when placed in pH 4, 7 and 9 buffered solutions (dashed responses) and when placed in mineral water solution (solid line). As expected the buffered solution responses are analogous to that shown in FIG. 4, in the case of the mineral water, a well-defined wave is observed between pH 7 and pH 9. Using the trend in peak potential with pH, the pH of the mineral water was found to be 7.69 which is in excellent agreement with that stated on the bottle of 7.7 (measured at source) and measured with a commercial glass pH electrode, 7.7.

The results described above show the importance of having a group within the proximity of the moiety to be oxidized or reduced which can promote hydrogen bonding and hence proton transfer between the solvent and the molecule.

The results above show that the oxidation of salicyaldehdye results in the formation of a species, which can then can then be used to determine the pH of a solution containing no natural buffer. As seen in the illustration, such an effect includes waves at high potentials at potentials where interference from other species/analytes is likely. For example, a comparison of the data shown in FIGS. 1 and 5, reveals that the newly active species has a redox potential, which is in a range similar to that a number of common redox active interferences, ascorbic acid, sulfide, catechol, uric acid, sulfide etc. and therefore the presence of these species in the analysis media would interfere with the redox signal of the peak used to determine the pH of the solution.

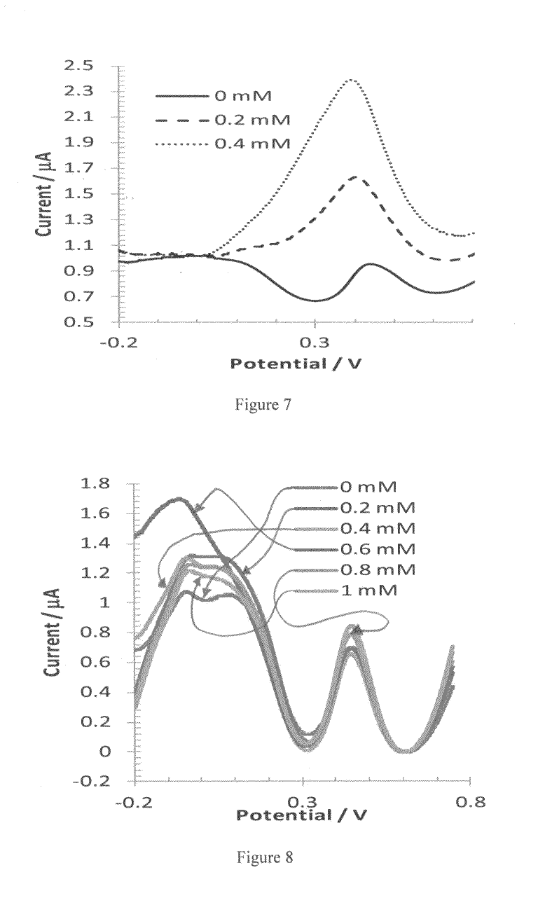

FIG. 7 highlights this effect, which shows the voltammetric response of a newly formed layer when placed in pH 7 solution to subsequent additions of ascorbic acid. It can be clearly seen that when Ascorbic acid is introduced to the solution a large oxidative wave is observed obscuring that of the underlying wave associated with the oxidation products of salicyaldehyde, this effect is enhanced as the concentration is increased. These results suggest that the presence of such species within analyte media will mean the sensor is no longer operable.

In embodiments of the present invention, methods and systems are provided for mitigating/eliminating the interferences. In one embodiment, this involves developing a protective redox and pH active layer/film upon the sensing electrode surface. The layer/film allows rapid proton transport from the analyte solution to the redox active center, however, in embodiments of the present invention the layer/film is thick enough to inhibit direct electron transfer between the interferent and the electrode substrate.

As highlighted above typically the direct oxidation of phenols at a bare electrode surface causes the formation of a plurality of polymeric layers upon the electrode surface, which passivates the electrode surface, thus inhibiting electron transfer from the electrode surface to the redox active molecule in solution. In the following, embodiments of the present invention are described in which the oxidation products of salicyladehyde provide not only a means of facilitating proton transfer from the solution to the redox active centre due to the structure of the molecule, but also as a way of effectively ‘passivating’ the electrode surface from redox active interferences within the analyte solution.

In this case a 1 mg/mL solution of salicyaldehyde in DCM is first prepared, 30 uL solution of this solution is placed on the electrode surface. This is done to ensure there is complete coverage of the surface with the parent compound. The electrode is then placed in aqueous media and, in accordance with an embodiment of the present invention, the potential is cycled as detailed in FIG. 2. In embodiments of the present invention, to ensure effective polymer growth the potential is repetitively cycled.

In certain cases the complete voltammetric profile is lost and in these cases the electrode is removed from the film formation solution and washed in a suitable solvent, (isopropanol, DCM or the like). The electrode is then placed back into the formation solution and cycled again. Once the protective film is formed the electrode is ready for use.

FIG. 8 details the square wave voltammetric response of a thick polymer film (greater than 1 mono later of coverage) to increasing additions of ascorbic acid (0 to 1 mM) when placed in pH 7 phosphate buffer.

In the figure, it can be seen that in the case of the thick film layer the polymer effectively passivates the electrode surface from redox active species within the solution. At the same time, however, the polymer allows proton transport through the redox centres to respond to the pH of the solution. It can be envisaged that the polymer chain is acting as a molecular wire, however, in embodiments of the present invention, the polymer is configured to be “tight” enough to both inhibit electron transfer from the fluid being analysed to the electrode and/or prevent diffusion of the interference species in the solution to the electrode.

The examples, describe embodiments comprising phenol derivatives, salicyaldehyde and/or the like. In other embodiments, the PTP may comprise phenol based polymers such as nitro phenol and derivatives of salicyadehdye. In embodiments of the present invention, the PTP comprises redox active centers and the polymer is configured such that protons are effectively transferred within through the polymer, but electrons are effectively passivated.

In embodiments of the present invention, passivation of the electrode on which the PTP is disposed with respect to the interferences is provided by providing a film of the PTP that is at least two layers/molecules thick. Fabrication of an electrode in accordance with an embodiment of the present invention may be provided by disposing the PTP on the electrode/in contact with the electrode and cycling a potential/current through/across the electrode.

In embodiments of the present invention, it was found that a film of two layers of the PTP were capable of preventing effects of interferences on the electrode. Thicknesses, of 3, 4, 5, 6, 7, 8, 9 and 10 were also found to be effective. Electrochemical sensors using electrodes with PTP with thickness of between 10 and 20, 30 and 40, 50 and 60, 70 and 80 and 90 and 100 layers/thicknesses of the PTP were found to provide very good isolation/prevention of interferences. Additionally thicknesses over 100 layers of PTP were found to eliminate effects of interferences. More importantly, at thicknesses of 10s or even 100s or above, it was found that the thickness did not adversely affect the response of the redox active centers and the communication of the response through the PTP to the electrode/substrate.

In embodiments of the present invention, thicknesses of 10s, 100s and above may be used in electrochemical sensors in which the electrode is in contact with a fluid to be measured for prolonged periods of time as the layer of PTP prevent diffusion of the interference to the electrode/substrate. In some embodiments, the PTP may be configured to resist diffusion of an interference through the PTP.

In embodiments of the present invention, the PTP may also comprise a non-sensitive redox species/center/moiety. As with the redox sensitive/active species, the non-sensitive redox species/center/moiety may be attached to the backbone of the PTP or similarly dispersed throughout the PTP. In other embodiments, the non-sensitive redox species/center may be attached to a sensing surface of the PTP. The non-sensitive redox species/center may comprise a ferrocene and/or the like. In embodiments of the present invention, the PTP provides that the redox sensitive species is not soluble so that contamination issues are prevented and the electrode may be used for biological testing, use on patients, food analysis and/or the like.

Alternative Structures

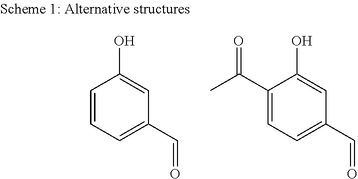

The above structures maybe used to form electroactive polymers on the electrode surface through oxidation of the phenol moiety. In the case of the right hand side structure the moieties required for the intramoleculare hydrogen bonding exist in the monomer, however the left hand side structure (3-hydroxybenzaldehyde) does not have the carbonyl moiety in the correct orientation to induce hydrogen bonding in the monomer. However, it can be envisaged than upon application of an oxidation potential the phenol moiety would oxidise to form the radical species, which could then undergo subsequent polymerisation reactions. It can be envisaged that once formed the carbonyl moiety would then be in the correct geometry with a oxygen group from a second monomer to facilitate proton transfer and hence determine pH in unbuffered media.

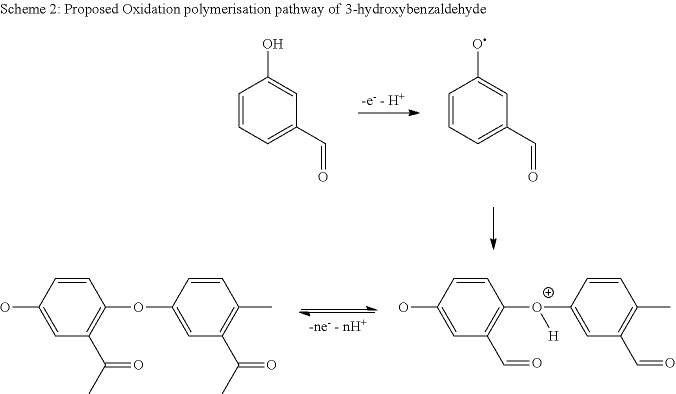

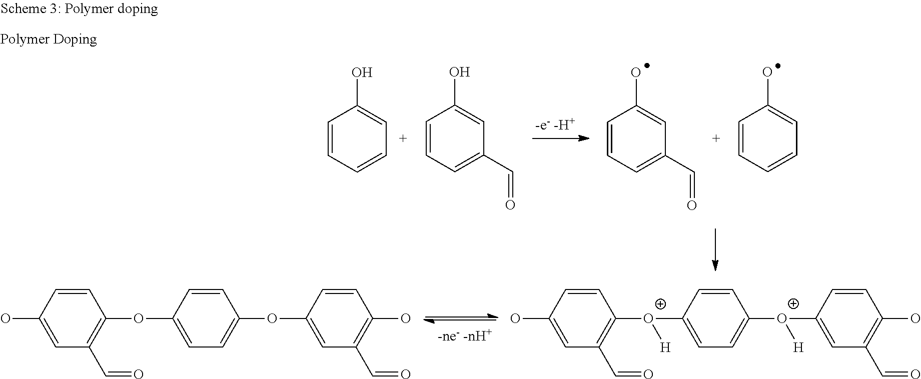

In an alternative polymer the salicyladehdye could be doped with phenol to induce a ‘tighter’ polymer to restrict the diffusion of other electroactive species through the polymer to the electrode surface.

In an embodiment of the present invention, a method of making an electrode for the electrochemical determination of a presence or measurement of an analyte is provide that comprises depositing a phenolic compound on a conductive substrate, where the phenolic compound has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group; and repeatedly electrochemically oxidising the phenolic compound in a one electron one proton oxidation so as to form a polymeric, water-insoluble, redox-active deposit on the conductive surface.

The oxygen atom may be part of a group in which there is a double bond to the oxygen atom, such as a carbonyl, nitro or sulpho group. A carbonyl group may be part of an aldehyde, keto or ester group. The relationship between this oxygen atom and the phenolic hydroxyl can be depicted as a partial structure:

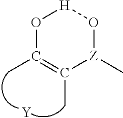

where: Y and the two carbon atoms connected to it comprise an aromatic ring with phenolic hydroxyl attached, and the oxygen atom joined to the ring through atom Z is able to participate in a hydrogen bond to the phenolic hydroxyl, as shown by a dotted line.

These phenolic compounds may be much less water-soluble than phenol itself and so may be applied to the conductive substrate by a process which deposits them onto the substrate. This may be application as a dispersion or solution in an organic solvent which is allowed to evaporate, leaving the phenolic compound immobilised on the surface of the substrate. Oxidation and polymerisation of the immobilised phenolic compound can then be brought about with the conductive substrate immersed in an electrolyte solution, which may be an aqueous solution and may be a buffer solution.

In embodiments of the present invention, the presence of and/or measurement of the analyte using an electrode comprising the plurality of layers of the may be provided by applying a potential to the electrode in a sweep over a range sufficient to bring about at least one oxidation and/or reduction of the redox active moiety; measuring potential or potentials at the peak current for one or more said oxidation and/or reductions; and processing the measurements to detect/measure the analyte.

In embodiments of the present invention an electrode comprising the PTP may be used in an electrochemical sensor that a working electrode comprising the PTP, a reference electrode comprising a redox insensitive species, such as a ferrocene or the like, and a counter electrode. The electrodes may be connected to a potentiostat, control unit and/or the like that are configured to provide electric power and produce measurement signals. The electrochemical sensor may include a regular electrochemical reference electrode. In some embodiments, the reference electrode and/or a further electrode comprising simply a conductive surface may be used to determine a presence of and/or an electrochemical signature of interferences moieties in the solution being analyzed. Output from such electrodes may be compared with an output from the working electrode to see if the passivation of the working electrode is effect and/or to process the output from the working electrode. In embodiments of the present invention, at least one of the electrodes are contacted with a fluid to be investigated.

A control unit may comprise a power supply, voltage supply, potentiostat and/or the like for applying an electrical potential to the working electrode and a detector, such as a voltmeter, a potentiometer, ammeter, resistometer or a circuit for measuring voltage and/or current and converting to a digital output, for measuring a potential between the working electrode and the counter electrode and/or the reference electrode 34 or 35 and for measuring a current flowing between the working electrode and the counter electrode (where the current flow will change as a result of the oxidation/reduction of a redox species).

A control unit/potentiostat may sweep a voltage difference across the electrodes and carry out voltammetry so that, for example, linear sweep voltammetry, cyclic voltammetry, or square wave voltammetry may be used to obtain measurements of the analyte using the electrochemical sensor. The control unit may include signal processing electronics.

A control unit 62 may be connected to a computer which receives current and/or voltage data from the sensor. This data may be the raw data of applied voltage and the current flowing at that voltage, or may be processed data which is the voltage at peak current. A control unit, such as a potentiostat may itself be controlled by a programmable computer giving a command to start a voltage sweep and possibly the computer will command parameters of the sweep such as its range of applied voltage and the rate of change of applied voltage.

In embodiments of the present invention, the PTP may be disposed as a paste on an electrode substrate, screen-printed on an electrode substrate, chemically reacted with an electrode substrate, solvent cast onto an electrode substrate and/or the like and then electrochemically oxidized repeatedly to form a plurality of layers of the PTO on the electrode substrate. Surprisingly, these multilayer PTP electrodes provide for both passivation of electron transfer from a solution being analyzed to the electrode substrate and facilitation of proton transfer through the PTP to the electrode substrate, providing for effective analyte measurement with limitation of the effects of interferences in the solution being tested.

In embodiments of the present invention, it was found that the PTP electrode had a response time of the order of 10s of milliseconds, which is faster than many existing electrochemical sensors. In fact, the response time was detrimentally effected by the thickness of the PTP. To the contrary, at thicknesses of the order of 100s of layers of the PTP, the electrode tended to act like a glass electrode with an instantaneous-type response.

In embodiments of the present invention, the use of PTP provides that the effect of interferences on the operation of electrochemical sensors is all but removed. This provides for utilization of the full range of features of the electrochemical sensor. As such, in one embodiment an electrochemical sensor comprising a PTP comprising a redox species that sensitive to pH at low ionic concentrations is provided. In another embodiment, the PTP is configured such that it influences the pH in front of the electrode. In one aspect the PTP comprises a configuration that influences the pH seen by the electrode and comprises a redox species sensitive to constituents found in water such as nitrates, calcium and/or the like.

In further embodiments of the present invention, the PTP comprises a plurality of redox active species each redox active sensor sensitive to a different analyte. For example, in one embodiment the PTP comprises a first redox species sensitive to pH and a second redox species sensitive to sulphites. In another embodiment, the PTP comprises a first redox species sensitive to pH and a second redox species sensitive to peroxide. Such combinations of redox sensitive species provides an electrochemical sensor that may be used to monitor production of an analyte where it may be necessary to monitor both concentration of the analyte being produced and the production conditions, such as pH or the like.

In embodiments of the present invention, because effects of interferences are attenuated/prevented, unlike in previous electrochemical sensors, a potentiometric window can be determined in which a reduction/oxidation current/potential of the sensitive redox species is expected/will occur. In previous electrochemical sensors, because the interferences affected the reduction/oxidation current/potential of the sensitive redox species, a full potentiometric sweep was necessary and could not be focussed on the reduction/oxidation current/potential of the sensitive redox species itself. As such, the electrochemical sensor/PTP electrode need only be swept/investigated in this potentiometric window. This increases response time of the electrochemical sensor as it reduces the potential sweep necessary for measuring/detecting the analyte. Additionally, this focussed potentiometric window, provides for improved signal analysis of the potentiometric waves produced by the sensor.

In some embodiments of the present invention because the polymer provides for passivation the electrode used to sense an analyte, calibration and/or testing the performance of the electrode can be carried out by a user of the electrode or a process in communication with the electrode. For example, with an electrode sensitive to pH, the electrode may be contacted with a water, mineral water, distilled water or the like and the output of the electrode can be tested against an expect reading of seven (7). In other embodiments, because the location of a reduction/oxidation peak or minimum is known with respect to a potential applied to the electrode, only potentials close to this potential need to be swept across the electrode to determine/measure a presence of an analyte to be detected, which among other things speeds up response time of the electrochemical sensor using the electrode.

In an embodiment of the present invention, a memory of the sensitive redox species integrated in the PTP, the reduction/oxidation current/potential of the sensitive redox species integrated in the PTP and/or the like is stored on the electrode comprising the PTP. This memory may comprise a software code, an RFID tag and/or the like. In operation of the electrochemistry sensor the memory is communicated to the electrochemistry sensor so that a potentiometric window may be swept when the electrochemical sensor is used and/or used by a signal processor in the electrochemical sensor to process received signals from the electrode. In electrochemical sensors where the electrode is not removeable, the memory may be stored in the electrochemical sensor itself and used for processing/operation.

In addition to the polymers sensitivity to protons/ability to transfer protons that, in accordance to an embodiment of the present invention, provides for its use in an electrochemical sensor, such as a pH sensor, the ability of the species to shuttle small cations through the layer allows for it to be used in alternative systems. In one embodiment, the proton/cation transfer polymer may be used in a battery. Merely by way of example, the proton/cation transfer polymer of the present disclosure may be used in a battery to provide for the exchange of protons with lithium ions during or after polymer formation. In such an embodiment, a polymer may be used in a lithium battery system under a two electrode system cathode:LTP:lithium, where the LTP consists of the saliycyladehyde (or its derivatives) base polymer.

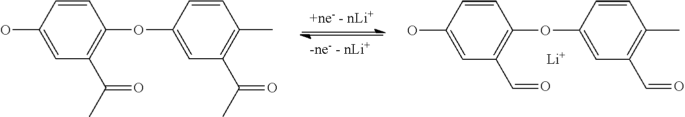 [SMILES: CC(=O)c1cc(Oc2ccc(O)cc2C(C)=O)ccc1C ; Cc1ccc(Oc2ccc(O)cc2C=O)cc1C=O ; [Li+]]

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A proton and/or cation transfer polymer for use in an electrochemical system comprising one of the following structures:

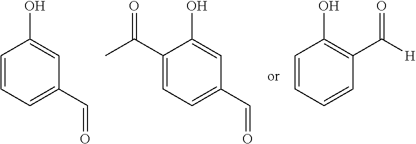

2. The proton and/or cation transfer polymer of claim 1 wherein the proton and/or cation transfer polymer comprises at least one of saliycyladehyde or one of its derivatives and a phenolic compound or a derivative thereof.

3. An electrode for an electrochemical sensor comprising a plurality of layers of the proton and/or cation transfer polymer of claim 1.

4. A lithium battery comprising the proton and/or cation transfer polymer of claim 1.

5. An electrode for an electrochemical sensor for sensing an analyte in a solution, comprising:
a substrate; and
a plurality of layers of a polymer sensitive to the analyte, wherein:
the polymer sensitive to the analyte comprises:
a redox sensitive moiety that is sensitive to the analyte; and
a facilitator of proton transfer that facilitates proton transfer from the solution to the substrate; and the plurality of layers of the polymer sensitive to the analyte passivates a transfer of electrons from the solution to the substrate.

6. The electrode of claim 1, wherein the polymer sensitive to the analyte comprises a phenolic compound.

7. The electrode of claim 6, wherein the phenolic compound comprises a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group.

8. The electrode of claim 7, wherein the electrode is produced by contacting/coupling the polymer sensitive to the analyte with a conductive substrate and repeatedly electrochemically oxidising the polymer sensitive to the analyte to form a multi-layer of a water-insoluble, redox-active, proton transfer facilitator polymer on the conductive substrate.

9. A method for producing a coated substrate for an electrochemical system, comprising:
contacting a conductive substrate with a proton/cation transfer facilitator polymer; and
repeatedly electrochemically oxidising the polymer to form a multi-layer of the proton/cation transfer facilitator polymer on the conductive substrate.

10. The method of claim 9, wherein the proton/cation transfer facilitator polymer comprises one of the following structures:

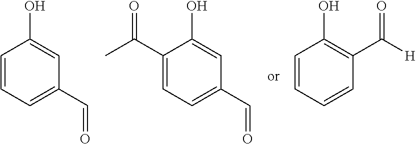

11. The method of claim 9, wherein the proton/cation transfer facilitator polymer comprises at least one of a saliycyladehyde or one of its derivatives and a phenolic compound or a derivative thereof.

12. A method for sensing an analyte in a solution, comprising:
contacting an electrode comprising a plurality of layers of a polymer comprising a coordinating group with respect to an ion of interest and a proton transfer facilitating group/moiety with the solution; and
measuring electrical properties of an oxidation and/or reduction of the coordinating group.

13. The method of claim 12, wherein the polymer comprises one of the following structures:

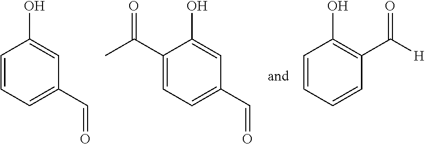

14. The method of claim 12, wherein the polymer comprises saliycyladehyde or one of its derivatives or a phenol or a phenol derivative.

15. A polymeric film for use in an energy device, comprising:
a polymer configured to provide for the transfer/movement of cations (Li, H+) through the polymer from a first electrode to a second electrode.

16. The polymeric film of claim 15, wherein the polymer comprises at least one of the following structures:

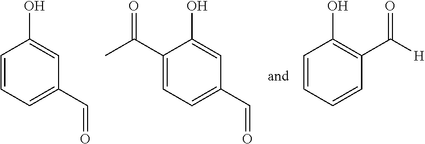

17. The polymer film of claim 15, wherein the polymer comprises saliycyladehyde or one of its derivatives or a phenol or a derivative thereof.

18. A battery, comprising
a first electrode;
a second electrode; and
a polymeric film disposed between the first and the second electrodes and configured in use to provide for the transfer/movement of cations (Li, H+) from the first electrode to the second electrode.
